(19) United States
(12) Patent Application Publication
(10) Pub. No.: US 2003/0234973 A1
(43) Pub. Date: Dec. 25, 2003

(54) Method and device for optical fiber transmission using raman amplification

(75) Inventors: Takashi Yamaguchi, Sapporo (JP); Toshihiro Ohtani, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/390,192

(22) Filed: Mar. 18, 2003

(30) Foreign Application Priority Data
Apr. 2, 2002 (JP) 2002-100364

(51) Int. Cl. H01S 3/00

(52) U.S. Cl. 359/334

(57) ABSTRACT

Disclosed herein is a method including the steps of providing an optical fiber transmission line for transmitting signal light; optically connecting a Raman amplifier having a pumping source for outputting pump light propagating in a direction opposite to the propagation direction of the signal light to the optical fiber transmission line; detecting the reflection of the pump light at a connection point between the Raman amplifier and the optical fiber transmission line; and controlling the Raman amplifier according to the reflection detected in the detecting step. According to this method, a lump loss can be easily detected in the case of performing Raman amplification, and any problem due to the lump loss can be prevented.

### BACKGROUND OF THE INVENTION

1. Field of the Invention

The present invention relates to a method and device for optical fiber transmission using Raman amplification.

2. Description of the Related Art

In recent years, a manufacturing technique and using technique for a low-loss (e.g., 0.2 dB/km) silica optical fiber have been established, and an optical communication system using the optical fiber as a transmission line has been put to practical use. Further, to compensate for losses in the optical fiber and thereby allow long-haul transmission, the use of an optical amplifier for amplifying an optical signal or signal light has been put to practical use.

An optical amplifier known in the art includes an optical amplifying medium to which signal light to be amplified is supplied and means for pumping the optical amplifying medium so that the optical amplifying medium provides a gain band including the wavelength of the signal light.

For example, an erbium doped fiber amplifier (EDFA) has already been developed to amplify signal light in a 1.55 μm band where the loss in a silica fiber is low. The EDFA includes an erbium doped fiber (EDF) as the optical amplifying medium and a pumping source for supplying pump light having a predetermined wavelength to the EDF. By preliminarily setting the wavelength of the pump light within a 0.98 μm band or a 1.48 μm band, a gain band including a wavelength of 1.55 μm can be obtained.

As a technique for increasing a transmission capacity by a single optical fiber, wavelength division multiplexing (WDM) is known. In a system adopting WDM, a plurality of optical carriers having different wavelengths are used. The plural optical carriers are individually modulated to thereby obtain a plurality of optical signals, which are wavelength division multiplexed by an optical multiplexer to obtain WDM signal light, which is output to an optical fiber transmission line. At a receiving end, the WDM signal light received is separated into individual optical signals by an optical demultiplexer, and transmitted data is reproduced according to each optical signal. Accordingly, by applying WDM, the transmission capacity in a single optical fiber can be increased according to the number of WDM channels.

By using an optical amplifier as a linear repeater, the number of parts in the repeater can be greatly reduced as compared with the case of using a conventional regenerative repeater, thereby ensuring reliability and allowing a substantial cost reduction.

Recently, there has been extensively examined the application of an optical repeater using Raman amplification capable of further reducing noise and broadening the band in addition to an EDFA. In the Raman amplification, an optical fiber generally used as an optical fiber transmission line is used as an optical amplifying medium, and pump light is supplied to the optical fiber. As a pumping source used in the Raman amplification, a high-power pumping source is required. Accordingly, it is expected that a recent tendency of a laser diode (LD) to have a high power and a high efficiency can accelerate practical utilization of the optical repeater using Raman amplification. Further, also in a remote amplifying method such that pumping is performed from an end of an optical fiber transmission line without using an optical repeater, the Raman amplification using a general optical fiber as an optical amplifying medium is useful in providing a distributed amplification system.

In general, variations in power of pump light to be actually introduced into an optical fiber as an optical amplifying medium in the case of performing Raman amplification largely affect a Raman gain. A loss (lump loss) at a connection point between the Raman amplifier and the optical fiber reduces the power of the pump light to be introduced into the optical amplifying medium, causing a reduction in the Raman gain. As described later in detail, a loss of 1 dB at a connection point in an optical connector causes a reduction of about 3 dB for the Raman gain. When the Raman gain is reduced to cause a reduction in signal light output from the Raman amplifier, an input level to an EDFA provided downstream of the Raman amplifier, for example, may be largely reduced to such an extent that it falls aside the input dynamic range of the EDFA.

Further, when the pump light is reflected at the connection point due to the lump loss, the reflected light from the connection point toward the pumping source such as a laser diode may have an adverse effect on the laser diode, because the power of the pump light is generally high.

The pump light for use in Raman amplification is input into the optical fiber with a power of 25 to 30 dBm. Accordingly, when reflection occurs at the connection point, there is a possibility of seizure of the end faces of the optical fibers connected together in the case that dirt or the like is deposited on the end faces.

In the case of constructing a system by using the Raman amplifier as an optical repeater, a degradation in transmission characteristics due to the lump loss cannot be easily specified. Further, if the system is started to operate with the lump loss remaining large, there is a case that the service life of a laser diode as a pumping source may become extremely short, because the laser diode is possibly driven near its rated power from the initial stage of the operation.

### SUMMARY OF THE INVENTION

It is therefore an object of the present invention to provide a method and device which can easily detect a lump loss in the case of performing Raman amplification to thereby prevent any problem due to the lump loss.

In accordance with an aspect of the present invention, there is provided a method comprising the steps of providing an optical fiber transmission line for transmitting signal light; optically connecting a Raman amplifier having a pumping source for outputting pump light propagating in a direction opposite to the propagation direction of said signal light to said optical fiber transmission line; detecting the reflection of said pump light at a connection point between said Raman amplifier and said optical fiber transmission line; and controlling said Raman amplifier according to the reflection detected in said detecting step.

According to this method, the reflection of the pump light at the connection point between the Raman amplifier and the optical fiber transmission line is detected, and the Raman amplifier is controlled according to the reflection detected. Accordingly, a lump loss can be easily detected in the case of performing Raman amplification, and any problem due to the lump loss can therefore be prevented.

In accordance with another aspect of the present invention, there is provided a device comprising an optical fiber transmission line for transmitting signal light; a Raman amplifier optically connected to said optical fiber transmission line, said Raman amplifier having a pumping source for outputting pump light propagating in a direction opposite to the propagation direction of said signal light; means for detecting the reflection of said pump light at a connection point between said Raman amplifier and said optical fiber transmission line; and means for controlling said Raman amplifier according to the reflection detected by said detecting means.

By using this device, the method according to the present invention can be easily performed.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram showing a system to which the present invention is applicable;

FIG. 2 is a block diagram of a conventional optical repeater applicable to the system shown in FIG. 1;

FIG. 3 is a graph showing the relation between Raman gain and pump light power;

FIG. 4 is a block diagram showing a preferred embodiment of the device (Raman amplifier) according to the present invention;

FIG. 5 is a block diagram showing the details of a portion shown by reference numeral 40 in FIG. 4;

FIG. 6 is a block diagram showing another preferred embodiment of the device (Raman amplifier) according to the present invention; and

FIG. 7 is a block diagram showing a further preferred embodiment of the device (Raman amplifier) according to the present invention.

### DESCRIPTION OF THE PREFERRED EMBODIMENTS

Some preferred embodiments of the present invention will now be described in detail with reference to the attached drawings.

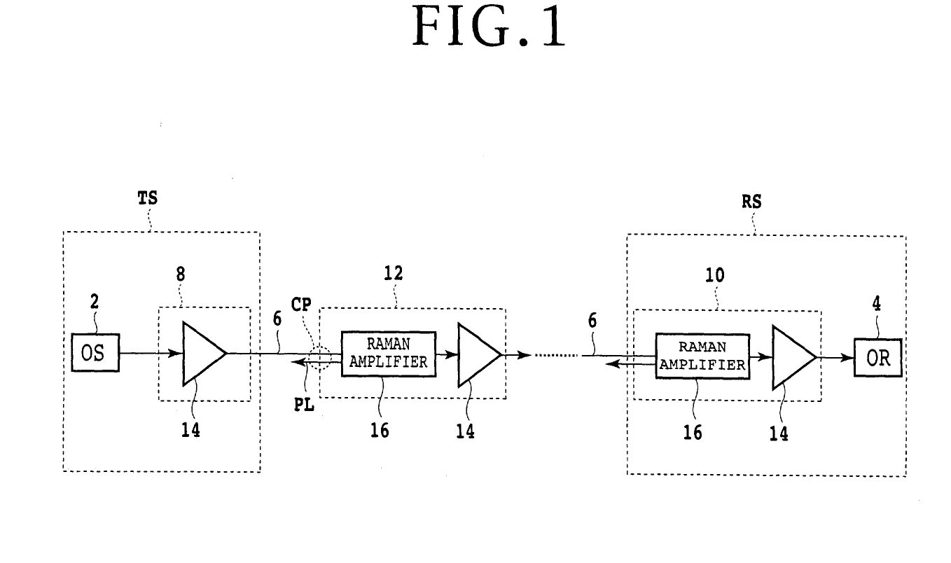

Referring to FIG. 1, there is shown a system to which the present invention is applicable. This system is constructed by installing an optical fiber transmission line 6 between an optical sender (OS) 2 and an optical receiver (OR) 4. The optical sender 2 and the optical receiver 4 may be adapted to a single wavelength channel or wavelength division multiplexing (WDM) using a plurality of wavelength channels.

An optical postamplifier 8 for increasing the power transmitted is provided just downstream of the optical sender 2, and an optical preamplifier 10 for increasing the power to be received is provided just upstream of the optical receiver 4. Further, an optical repeater 12 is provided in the middle of the optical fiber transmission line 6. Although the single optical repeater 12 is shown in FIG. 1, a plurality of optical repeaters may be used.

The optical postamplifier 8 includes an EDFA (erbium doped fiber amplifier) 14, and each of the optical preamplifier 10 and the optical repeater 12 includes a Raman amplifier 16 in addition to an EDFA 14.

Although not shown in detail, each EDFA 14 includes an EDF (erbium doped fiber) and a pumping source for supplying pump light having a predetermined wavelength to the EDF so that the EDF provides a gain band. Optical components for introducing the pump light output from the pumping source into the EDF are also included in each EDFA 14. Each Raman amplifier 16 includes a pumping source and optical components for introducing pump light PL into the optical fiber transmission line 6 in a direction opposite to the direction of propagation of signal light to be amplified. In each EDFA 14, the EDF functions as an optical amplifying medium, whereas in each Raman amplifier 16, the optical fiber transmission line 6 provided just upstream of the Raman amplifier 16 functions as an optical amplifying medium.

In principle, Raman gain can be obtained in each Raman amplifier 16 also in the case of supplying pump light in the same direction as the direction of propagation of signal light. In this case, however, there is a possibility that the total power of the propagating light (the signal light and the pump light) in the optical fiber transmission line 6 may become too large to cause the occurrence of unwanted nonlinear optical effects. To avoid such a disadvantage, the pump light is supplied in the opposite direction to the propagation direction of the signal light in this preferred embodiment.

The optical sender 2 and the optical postamplifier 8 are included in a transmitting station TS, and the optical preamplifier 10 and the optical receiver 4 are included in a receiving station RS.

In the system shown in FIG. 1, the pump light PL is reflected at a connection point by an optical connector as shown by CP. The reflected light is returned to the Raman amplifier 16 to cause various problems mentioned above. Accordingly, to allow a stable system operation, it is required to grasp the reflection of pump light in a Raman amplification process and to use the reflection grasped for the control or management of the system.

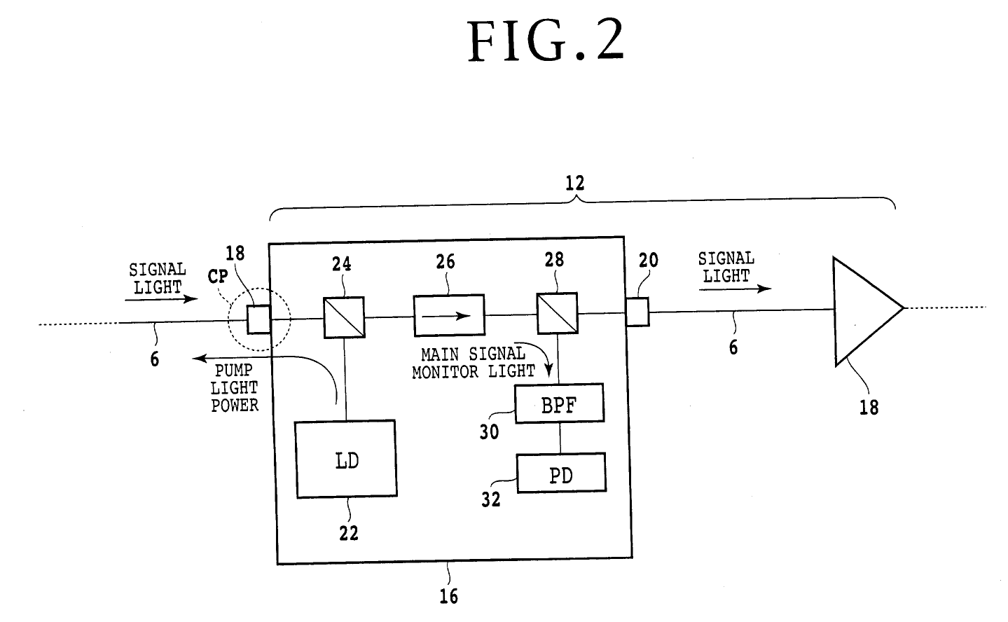

Referring to FIG. 2, there is shown a conventional configuration used as the optical repeater 12. The Raman amplifier 16 has an input optically connected through an optical connector 18 to the upstream optical fiber transmission line 6 and an output optically connected through an optical connector 20 to the downstream optical fiber transmission line 6. Pump light output from a laser diode (LD) 22 as a pumping source for providing Raman gain is input through a WDM optical coupler 24 and the optical connector 18 into the upstream optical fiber transmission line 6 in the direction opposite to the propagation direction of signal light. Accordingly, the Raman gain is obtained in the upstream optical fiber transmission line 6 to thereby amplify the signal light.

The signal light thus amplified is passed through the WDM optical coupler 24 and next passed through an optical isolator 26, an optical coupler 28, and the optical connector 20 in this order. Then, the signal light is output from the optical connector 20 to the downstream optical fiber transmission line 6 connected to the EDFA 14. The coupling ratio of the WDM optical coupler 24 has wavelength dependence, so that the signal light and the pump light different in wavelength are passed along different routes in the WDM optical coupler 24. On the other hand, the coupling ratio of the optical coupler 28 has no wavelength dependence, and a part of the signal light to which the Raman gain has been given is branched off as main signal monitor light by the optical coupler 28.

The main signal monitor light branched off by the optical coupler 28 is input through an optical bandpass filter (BPF) 30 having a passband including the wavelength of the signal light, into a photodetector (PD) 32. Accordingly, output level control or the like for the Raman amplifier 16 can be easily performed according to an output from the photodetector 32.

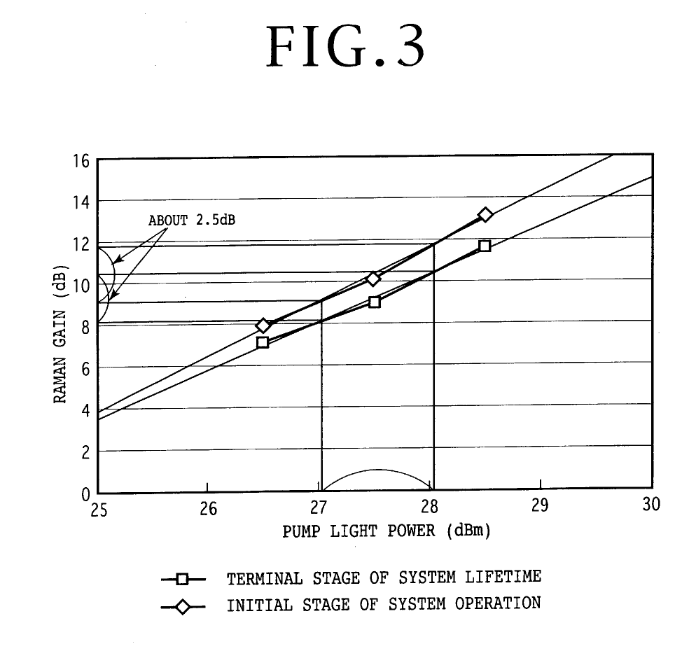

FIG. 3 is a graph showing the relation between Raman gain and pump light power. It is understood from this graph that when the pump light power changes by 1 dB, for example, the Raman gain accordingly changes by about 2.5 to 3.0 dB.

In the configuration shown in FIG. 2, the pump light output from the LD 22 incurs loss upon passing through the optical connector 18. As a result, a change (decrease) in Raman gain larger than the above loss is produced in accordance with the relation shown in FIG. 3. At the same time, reflection of the pump light also occurs upon passing through the optical connector 18.

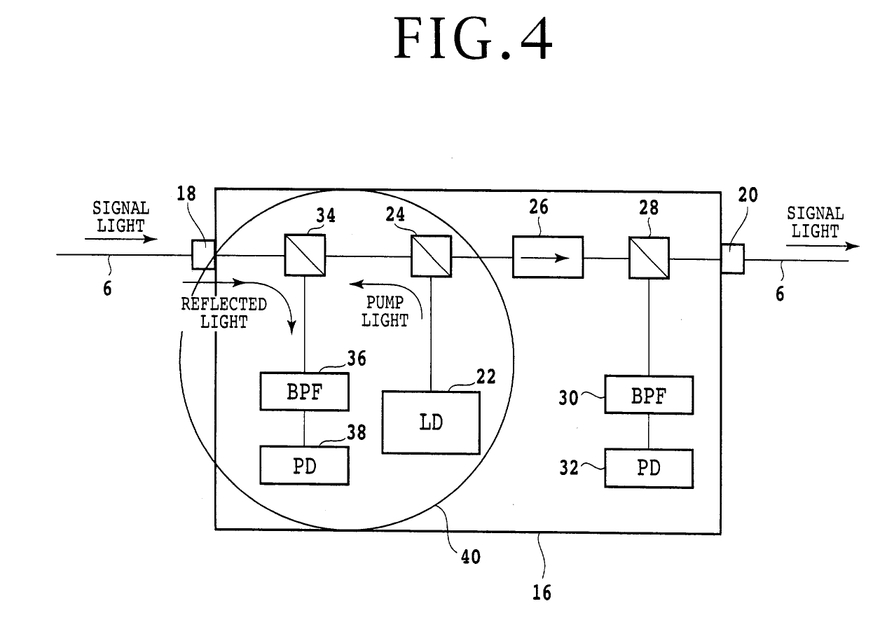

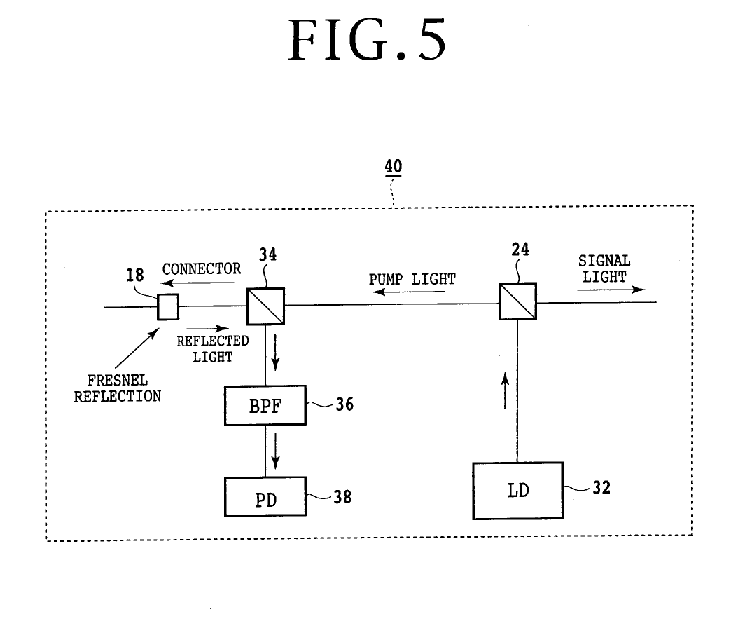

FIG. 4 is a block diagram showing a preferred embodiment of the device (Raman amplifier) according to the present invention, and FIG. 5 is a block diagram showing the details of a portion shown by reference numeral 40 in FIG. 4.

In contrast to the configuration shown in FIG. 2, this preferred embodiment further includes an optical coupler 34, an optical bandpass filter (BPF) 36, and a photodetector (PD) 38, so as to detect the reflection of the pump light at the optical connector 18 provided on the input side of the Raman amplifier 16. The optical coupler 34 is provided between the optical connector 18 and the WDM optical coupler 24. The optical bandpass filter 36 is optically connected to the optical coupler 34, and the photodetector 38 is optically connected to the optical bandpass filter 36.

The function required of the optical coupler 34 is to pass the pump light propagating in the direction opposite to the propagation direction of the signal light in the optical fiber transmission line 6 and to branch off the reflected pump light propagating from the optical connector 18 in the same direction as the propagation direction of the signal light toward the optical bandpass filter 36. Accordingly, an optical coupler having a coupling ratio (independent of wavelength) of 1:10, for example, may be used as the optical coupler 34.

The pump light output from the laser diode 22 is passed through the optical couplers 24 and 34 in this order and supplied from the optical connector 18 to the optical fiber transmission line 6 in the direction opposite to the propagation direction of the signal light. A part of the reflected pump light from the optical connector 18 is extracted by the optical coupler 34 and supplied to the optical bandpass filter 36. At this time, the signal light propagating in the same direction as the propagation direction of the reflected pump light coexists with the reflected pump light. The optical bandpass filter 36 has a passband including the wavelength of the pump light and excluding the wavelength of the signal light. Therefore, only the reflected pump light is passed through the optical bandpass filter 36, and then converted into an electrical signal according to the power of the reflected pump light by the photodetector 38.

According to this preferred embodiment, the reflection of the pump light at the optical connector 18 can be detected simply, so that in the case of performing Raman amplification, a lump loss can be easily detected and any problem due to the lump loss can be prevented. For example, the Raman amplifier 16 can be controlled according to the detection of the lump loss. Specific examples of this control will now be described.

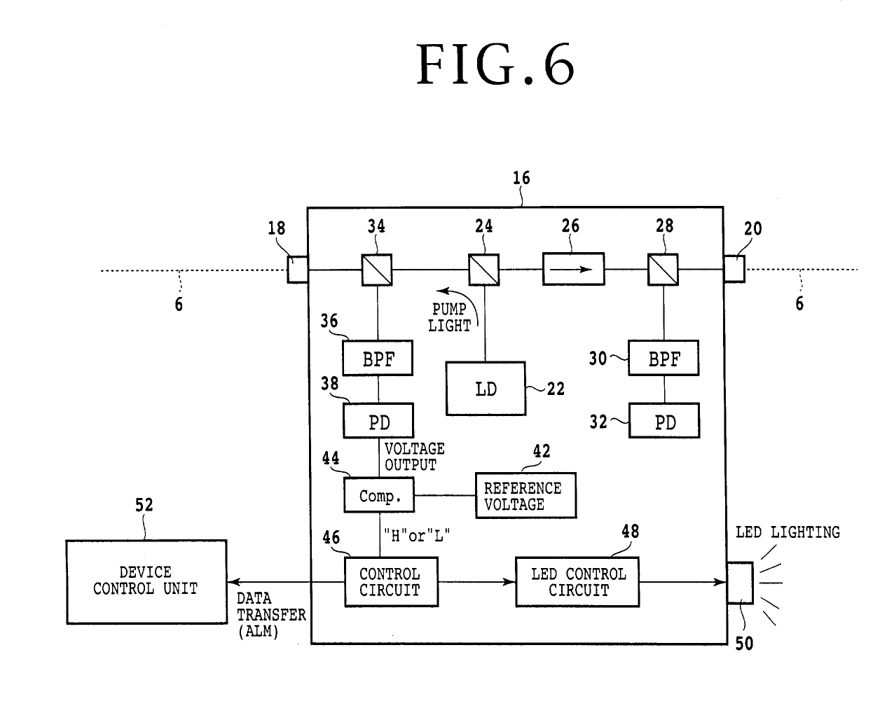

FIG. 6 is a block diagram showing another preferred embodiment of the device (Raman amplifier) according to the present invention. This preferred embodiment is intended to perform control according to the detection of the reflection of pump light at the optical connector 18. Accordingly, in contrast to the preferred embodiment shown in FIGS. 4 and 5, the preferred embodiment shown in FIG. 6 further includes a reference voltage source 42, comparator (Comp.) 44, control circuit 46, LED control circuit 48, LED 50, and device control unit 52.

In the comparator 44, the voltage output from the photodetector 38 according to the power of the reflected pump light is compared with a reference voltage (Ref.) output from the reference voltage source 42. Then, an “H” or “L” signal as the result of this comparison is sent to the control circuit 46. A control signal from the control circuit 46 is sent to the LED control circuit 48 and the device control unit 52, thereby controlling the LED 50 and the Raman amplifier 16.

For example, the control circuit 46 and the device control unit 52 performs control such that when the level of reflection of the pump light detected by the photodetector 38 is greater than a predetermined level, the power of the laser diode 22 as a pumping source is cut off or reduced. Accordingly, it is possible to prevent the seizure of the optical fiber end faces at the connection point and the deterioration of the LD due to the reflection of the pump light having a relatively high power.

Further, the control circuit 46 and the LED control circuit 48 control lighting of the LED 50 to issue an alarm to the operator when the level of reflection of the pump light detected by the photodetector 38 is greater than a predetermined level. Accordingly, the operator can easily recognize the occurrence of a lump loss, thereby allowing rapid removal of any problem due to the reflection of pump light.

Although not shown, the control circuit 46 can adjust the gain by the Raman amplifier 16 according to the level of reflection of the pump light detected by the photodetector 38. The gain adjustment may be effected by controlling a drive current for the laser diode 22 as a pumping source. For example, when the level of reflection of the pump light detected is high, the power of the pump light is increased by an amount corresponding to the lump loss, whereas when the level of reflection of the pump light detected is low, the power of the pump light is decreased. Accordingly, variations in Raman gain due to the reflection of pump light can be effectively prevented.

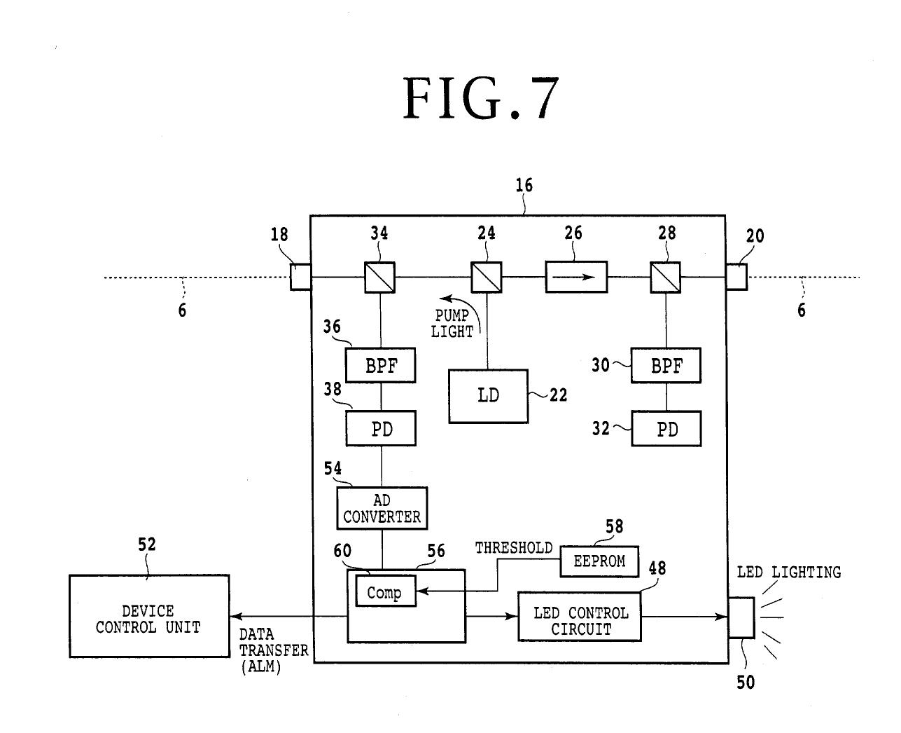

FIG. 7 is a block diagram showing a further preferred embodiment of the device (Raman amplifier) according to the present invention. In the preferred embodiment shown in FIG. 6, various control objects in the Raman amplifier 16 are analog-controlled. In contrast thereto, the preferred embodiment shown in FIG. 7 performs control by digital computation, so that an AD (analog-digital) converter 54, an EEPROM 58, and a digital processor 56 are used in place of the comparator 44, the reference voltage source 42, and the control circuit 46 (see FIG. 6).

The voltage output from the photodetector 38 is converted into digital data by the AD converter 54, and this digital data is supplied to the digital processor 56. In the digital processor 56, threshold data preliminarily stored in the EEPROM 58 is referred and a comparative operation program 60 is executed by using the digital data supplied and the threshold data referred above to thereby perform control similar to the analog control in the preferred embodiment shown in FIG. 6.

The threshold data on the reflection level of pump light to be preliminarily stored in the EEPROM 58 will now be examined. Assuming that the pump light power from the laser diode 22 is 25 dBm, the amount of Fresnel reflection at the optical connector 18 becomes about 11 dBm, and the input level to the photodetector 38 becomes about 0 dBm in consideration of the losses at the optical coupler 34 and the optical bandpass filter 36. Accordingly, by preliminarily setting the threshold to about −5 dBm, a lump loss can be easily detected.

This preferred embodiment can also exhibit an effect similar to that in the preferred embodiment shown in FIG. 6.

According to the present invention as described above, it is possible to provide a method and device which can easily detect a lump loss in the case of performing Raman amplification to thereby prevent any problem due to the lump loss. The effects obtained by the specific preferred embodiments of the present invention have been described above.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method comprising the steps of:
providing an optical fiber transmission line for transmitting signal light;
optically connecting a Raman amplifier having a pumping source for outputting pump light propagating in a direction opposite to the propagation direction of said signal light to said optical fiber transmission line;
detecting the reflection of said pump light at a connection point between said Raman amplifier and said optical fiber transmission line; and
controlling said Raman amplifier according to the reflection detected in said detecting step.

2. A method according to claim 1, wherein said controlling step comprises the step of issuing an alarm when the level of the reflection detected is greater than a predetermined level.

3. A method according to claim 1, wherein said controlling step comprises the step of cutting off the power of said pumping source when the level of the reflection detected is greater than a predetermined level.

4. A method according to claim 1, wherein said controlling step comprises the step of reducing the power of said pumping source when the level of the reflection detected is greater than a predetermined level.

5. A method according to claim 1, wherein said controlling step comprises the step of adjusting the gain of said Raman amplifier according to the level of the reflection detected.

6. A method according to claim 1, wherein said detecting step comprises the step of providing an optical bandpass filter having a passband including the wavelength of said pump light.

7. A method according to claim 6, wherein said controlling step comprises the steps of converting the power of light passed through said optical bandpass filter into a voltage value, and comparing said voltage value with a reference value.

8. A method according to claim 6, wherein said controlling step comprises the steps of converting the power of light passed through said optical bandpass filter into a digital signal, and executing a comparative operation between said digital signal and threshold data preliminarily stored.

9. A device comprising:
an optical fiber transmission line for transmitting signal light;
a Raman amplifier optically connected to said optical fiber transmission line, said Raman amplifier having a pumping source for outputting pump light propagating in a direction opposite to the propagation direction of said signal light;
means for detecting the reflection of said pump light at a connection point between said Raman amplifier and said optical fiber transmission line; and
means for controlling said Raman amplifier according to the reflection detected by said detecting means.

10. A device according to claim 9, wherein said controlling means comprises means for issuing an alarm when the level of the reflection detected is greater than a predetermined level.

11. A device according to claim 9, wherein said controlling means comprises means for cutting off the power of said pumping source when the level of the reflection detected is greater than a predetermined level.

12. A device according to claim 9, wherein said controlling means comprises means for reducing the power of said pumping source when the level of the reflection detected is greater than a predetermined level.

13. A device according to claim 9, wherein said controlling means comprises means for adjusting the gain of said Raman amplifier according to the level of the reflection detected.

14. A device according to claim 9, wherein said detecting means comprises an optical bandpass filter having a passband including the wavelength of said pump light.

15. A device according to claim 14, wherein said controlling means comprises means for converting the power of light passed through said optical bandpass filter into a voltage value, and means for comparing said voltage value with a reference value.

16. A device according to claim 14, wherein said controlling means comprises means for converting the power of light passed through said optical bandpass filter into a digital signal, and means for executing a comparative operation between said digital signal and threshold data preliminarily stored.
